(19) United States
(12) Patent Application Publication
(10) Pub. No.: US 2012/0095729 A1
(43) Pub. Date: Apr. 19, 2012

(54) KNOWN INFORMATION COMPRESSION APPARATUS AND METHOD FOR SEPARATING SOUND SOURCE

(75) Inventors: Min Je KIM, Daejeon (KR); Tae Jin LEE, Daejeon (KR); In Seon JANG, Daejeon (KR); Seung Kwon BEACK, Seoul (KR); Kyeong Ok KANG, Daejeon (KR)

(73) Assignee: Electronics and Telecommunications Research Institute, Daejeon (KR)

(21) Appl. No.: 13/273,833

(22) Filed: Oct. 14, 2011

(30) Foreign Application Priority Data
Oct. 14, 2010 (KR) 10-2010-0100440
Jun. 1, 2011 (KR) 10-2011-0052905

(51) Int. Cl. G06F 15/00

(52) U.S. Cl. 702/190

(57) ABSTRACT

A known information compression apparatus and method for reducing a size of known information without missing information required to separate a sound source are provided. The known information compression apparatus may include a segment dividing unit to divide known information including sound source information of each musical instrument into a plurality of segments, and a compressed information generating unit to downmix the segments and to generate compressed information.

### CROSS-REFERENCE TO RELATED APPLICATIONS

This application claims the benefit of Korean Patent Application No. 10-2010-0100440 and of Korean Patent Application No. 10-2011-0052905, respectively filed on Oct. 14, 2010 and Jun. 1, 2011, in the Korean Intellectual Property Office, the disclosures of which are incorporated herein by reference.

### BACKGROUND

1. Field of the Invention

The present invention relates to a known information compression apparatus and method that may process a large amount of known information using a sound source separation scheme. More particularly, the present invention relates to a known information compression apparatus and method that may reduce a size of known information without missing information required to separate a sound source.

2. Description of the Related Art

A sound source separation apparatus may separate a sound source played on a musical instrument corresponding to known information from a mixed signal that includes sound source information generated by simultaneously playing a plurality of musical instruments.

For example, the sound source separation apparatus may extract information corresponding to the known information from the mixed signal using a Nonnegative Matrix Partial Co-Factorization (NMPCF) algorithm, and may separate the sound source played on the musical instrument corresponding to the known information, based on the extracted information.

However, since known information is used as reference information to determine a characteristic of the sound source played on the corresponding musical instrument, the known information needs to include sound source information generated by playing only the corresponding musical instrument for a predetermined period of time. In other words, an amount of the known information that is merely the reference information becomes greater than a predetermined amount, and accordingly the sound source separation apparatus requires a calculation performance above a predetermined level, to process the known information.

Accordingly, there is a need for a method that may reduce a size of known information used in the sound source separation apparatus, and may separate a sound source, even when a calculation apparatus with a low performance is used.

### SUMMARY

An aspect of the present invention provides a known information compression apparatus and method that may compress known information while maintaining a characteristic of a corresponding musical instrument, so that the known information may be reduced in size without missing information required to separate a sound source.

Another aspect of the present invention provides a known information compression apparatus and method that may reduce a size of known information, namely, reference information used to separate a sound source, and may separate a sound source even in a calculation apparatus with a low performance.

According to an aspect of the present invention, there is provided a known information compression apparatus, including: a segment dividing unit to divide known information into a plurality of segments, the known information including sound source information of each musical instrument; and a compressed information generating unit to downmix the segments and to generate compressed information.

According to another aspect of the present invention, there is provided a known information compression method, including: dividing known information into a plurality of segments, the known information including sound source information of each musical instrument; and downmixing the segments and generating compressed information.

### EFFECT

According to embodiments of the present invention, it is possible to compress known information while maintaining a characteristic of a corresponding musical instrument, so that the known information may be reduced in size, without missing information required to separate a sound source.

Additionally, according to embodiments of the present invention, it is possible to reduce a size of known information, namely, reference information used to separate a sound source, and to separate a sound source even in a calculation apparatus with a low performance.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a known information compression apparatus according to an embodiment of the present invention;

FIG. 2 is a diagram illustrating an example of generating compressed information according to an embodiment of the present invention; and

FIG. 3 is a flowchart illustrating a known information compression method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

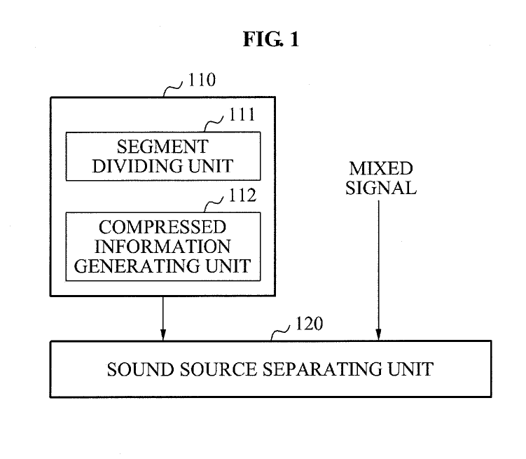

FIG. 1 is a block diagram illustrating a known information compression apparatus 110 according to an embodiment of the present invention.

Referring to FIG. 1, the known information compression apparatus 110 may include a segment dividing unit 111, and a compressed information generating unit 112.

The segment dividing unit 111 may divide known information into a plurality of segments. The known information may include sound source information of each musical instrument. Additionally, the known information may include a plurality of entity matrices. The plurality of entity matrices may include frequency information of a sound source generated by a musical instrument.

Specifically, when the known information corresponds to a time domain signal, the segment dividing unit 111 may segment the known information into equal-sized segments along a time axis. Additionally, when the known information does not correspond to the time domain signal, or corresponds to a time-frequency domain signal, the segment dividing unit 111 may transform the known information to a spectrogram represented by both time and frequency, and may divide the spectrogram into equal-sized segments along the time axis. The spectrogram may include information obtained by combining a characteristic of a waveform with a characteristic of a spectrum. For example, a short-time Fourier transform (STFT), or Fourier transform (FT) may be used to transform the known information to the spectrogram.

The compressed information generating unit 112 may downmix the segments into which the known information is divided by the segment dividing unit 111, and may generate compressed information. The compressed information may be obtained by overlapping(*combining a plurality of pieces of frequency information in each of the entity matrices.

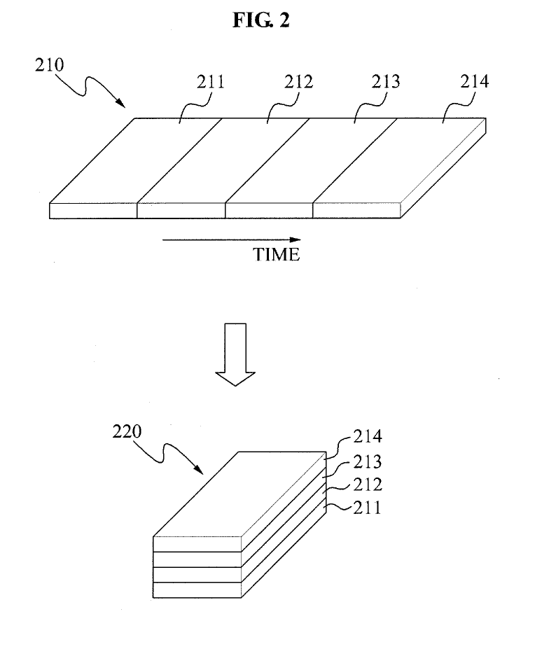

Specifically, the compressed information generating unit 112 may downmix temporally consecutive segments into a single segment. An operation by which the compressed information generating unit 112 compresses segments will be further described with reference to FIG. 2.

Additionally, the compressed information generating unit 112 may provide the generated compressed information to the sound source separating unit 120. The sound source separating unit 120 may separate a plurality of pieces of frequency information from entity matrices of the compressed information, using a Nonnegative Matrix Partial Co-Factorization (NMPCF) algorithm and accordingly, it is possible to obtain a similar effect to separating frequency information from the known information. Additionally, the sound source separating unit 120 may separate a sound source played on a musical instrument corresponding to the known information, from a mixed signal based on the separated pieces of frequency information. The mixed signal may include sound source information generated by simultaneously playing a plurality of musical instruments. Specifically, the sound source separating unit 120 may extract information corresponding to the pieces of frequency information from the mixed signal, using the NMPCF algorithm, and may separate the sound source played on the musical instrument corresponding to the known information, based on the extracted information.

Thus, the known information compression apparatus 110 may compress known information while maintaining a characteristic of a corresponding musical instrument and accordingly, the known information may be reduced in size without missing information required to separate a sound source, and may be provided to the sound source separating unit 120.

FIG. 2 is a diagram of an example of generating compressed information according to an embodiment of the present invention.

As shown in FIG. 2, the segment dividing unit 111 of FIG. 1 may divide known information 210 into equal-sized segments 211, 212, 213, and 214 along a time axis.

The compressed information generating unit 112 of FIG. 1 may downmix the segments 211, 212, 213, and 214 into a single segment, and may generate compressed information 220.

For example, when a segment includes “1025×218” entity matrices, and when each of the “1025×218” entity matrices has a size of 64 bits, each of the segments 211, 212, 213, and 214 may have a size of 1.7 megabytes (MB) obtained by multiplying “64” bits by “1025×218” entity matrices. Additionally, the known information 210 has a size of 6.8 MB obtained by multiplying 1.7 MB by 4, that is, obtained by summing up the sizes of the segments 211, 212, 213, and 214. However, since the compressed information generating unit 112 compresses the known information 210 to be the compressed information 220 corresponding to a size of a single segment, by adding pieces of information included in the segments 211, 212, 213, and 214, the sound source separating unit 120 may achieve the same effect as information with the size of 6.8 MB, by using information with the size of 1.7 MB. Additionally, the known information 210 may require a time to transmit a single segment about four times, whereas the compressed information 220 may receive all information for a time required to transmit a single segment once.

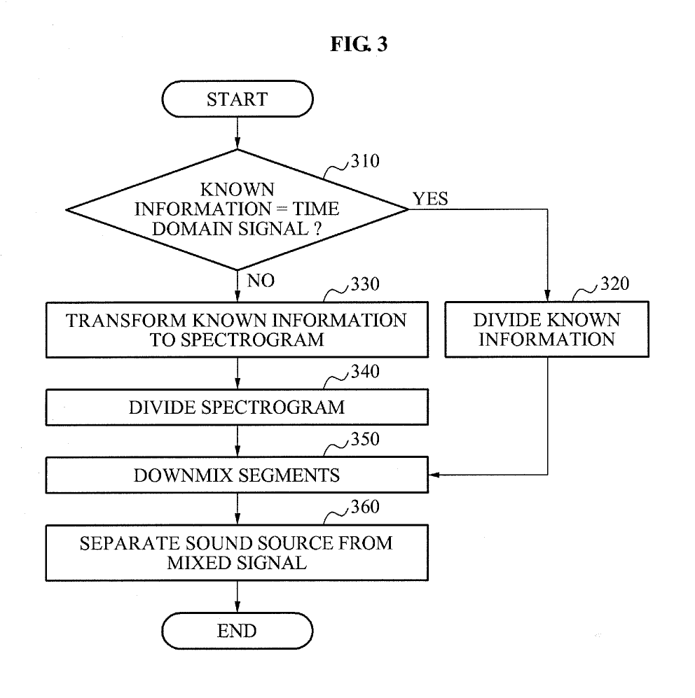

FIG. 3 is a flowchart of a known information compression method according to an embodiment of the present invention.

In operation 310, the segment dividing unit 111 of FIG. 1 may determine whether known information corresponds to a time domain signal.

When it is determined that the known information corresponds to the time domain signal in operation 310, the segment dividing unit 111 may divide the known information into equal-sized segments along a time axis in operation 320.

When it is determined that the known information does not correspond to the time domain signal in operation 310, the segment dividing unit 111 may transform the known information to a spectrogram represented by both time and frequency in operation 330. For example, the SIFT may be used to transform the known information to the spectrogram.

In operation 340, the segment dividing unit 111 may divide the spectrogram obtained in operation 330 into equal-sized segments, along the time axis.

In operation 350, the compressed information generating unit 112 of FIG. 1 may downmix the segments that are obtained in operation 320 or 340, and may generate compressed information. The compressed information may be obtained by overlapping(*combining a plurality of pieces of frequency information in each of the entity matrices.

Specifically, the compressed information generating unit 112 may downmix temporally consecutive segments into a single segment.

In operation 360, the sound source separating unit 120 of FIG. 1 may separate a sound source played on a musical instrument corresponding to the known information, from a mixed signal based on the compressed information.

Specifically, the sound source separating unit 120 may separate a plurality of pieces of frequency information from entity matrices of the compressed information, using a NMPCF algorithm, and may separate the sound source played on the musical instrument corresponding to the known information, from the mixed signal based on the separated pieces of frequency information. The mixed signal may include sound source information generated by simultaneously playing a plurality of musical instruments.

According to embodiments of the present invention, it is possible to compress known information while maintaining a characteristic of a corresponding musical instrument, so that the known information may be reduced in size, without missing information required to separate a sound source.

Additionally, according to embodiments of the present invention, it is possible to reduce a size of known information, namely, reference information used to separate a sound source, and to separate a sound source even in a calculation apparatus with a low performance.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A known information compression apparatus, comprising:
a segment dividing unit to divide known information into a plurality of segments, the known information including sound source information of each musical instrument; and
a compressed information generating unit to downmix the segments and to generate compressed information.

2. The known information compression apparatus of claim 1, wherein the segment dividing unit transforms the known information to a spectrogram represented by both time and frequency, and divides the spectrogram into equal-sized segments along a time axis.

3. The known information compression apparatus of claim 1, wherein, when the known information corresponds to a time domain signal, the segment dividing unit divides the known information into equal-sized segments along a time axis.

4. The known information compression apparatus of claim 1, wherein the compressed information generating unit downmixes temporally consecutive segments into a single segment.

5. The known information compression apparatus of claim 1, wherein the known information comprises a plurality of entity matrices.

6. The known information compression apparatus of claim 5, wherein the plurality of entity matrices comprise frequency information of a sound source generated by each musical instrument.

7. The known information compression apparatus of claim 6, wherein the compressed information is obtained by overlapping(*combining a plurality of pieces of frequency information in each of the entity matrices.

8. A sound source separation apparatus, comprising:
a segment dividing unit to divide known information into a plurality of segments, the known information including sound source information of each musical instrument;
a compressed information generating unit to downmix the segments and to generate compressed information; and
a sound source separating unit to separate pieces of frequency information from the compressed information, and to separate a sound source played on a musical instrument corresponding to the known information, from a mixed signal based on the separated pieces of frequency information, the mixed signal including sound source information generated by simultaneously playing a plurality of musical instruments.

9. A known information compression method, comprising:
dividing known information into a plurality of segments, the known information including sound source information of each musical instrument; and
downmixing the segments and generating compressed information.

10. The known information compression method of claim 9, wherein the dividing comprises transforming the known information to a spectrogram represented by both time and frequency, and dividing the spectrogram into equal-sized segments along a time axis.

11. The known information compression method of claim 9, wherein the dividing comprises, when the known information corresponds to a time domain signal, dividing the known information into equal-sized segments along a time axis.

12. The known information compression method of claim 9, wherein the downmixing comprises downmixing temporally consecutive segments into a single segment.

13. The known information compression method of claim 9, wherein the known information comprises a plurality of entity matrices.

14. The known information compression method of claim 13, wherein the plurality of entity matrices comprise frequency information of a sound source generated by each musical instrument.

15. The known information compression method of claim 14, wherein the compressed information is obtained by overlapping(*combining a plurality of pieces of frequency information in each of the entity matrices.

16. A sound source separation method, comprising:
dividing known information into a plurality of segments, the known information including sound source information of each musical instrument;
downmixing the segments and generating compressed information;
separating pieces of frequency information from the compressed information; and
separating a sound source played on a musical instrument corresponding to the known information, from a mixed signal based on the separated pieces of frequency information, the mixed signal including sound source information generated by simultaneously playing a plurality of musical instruments.
